(19) United States
(12) Patent Application Publication
(10) Pub. No.: US 2017/0277077 A1
(43) Pub. Date: Sep. 28, 2017

(54) DEVELOPER TRANSPORT DEVICE AND IMAGE FORMING APPARATUS

(71) Applicant: FUJI XEROX CO., LTD., Tokyo (JP)

(72) Inventors: Ayumi NOGUCHI, Kanagawa (JP); Shota OBA, Kanagawa (JP); Norihiro TAMAZAWA, Kanagawa (JP)

(73) Assignee: FUJI XEROX CO., LTD., Tokyo (JP)

(21) Appl. No.: 15/229,300

(22) Filed: Aug. 5, 2016

(30) Foreign Application Priority Data
Mar. 23, 2016 (JP) 2016-058764

(51) Int. Cl. G03G 15/08

(52) U.S. Cl. CPC G03G 15/0891

(57) ABSTRACT

A developer transport device includes a transport path through which a developer is transported from a developer container to a developing device; an inlet portion that is disposed at an upstream end of the transport path in a developer transport direction and into which the developer falls freely from an outlet opening of the developer container; a transport member that is disposed in the transport path and that transports the developer by rotating; and a rotation control unit that causes, if the transport member has not been driven for a predetermined period, the transport member to rotate in a backward direction that is opposite to a forward direction in which the transport member rotates when supplying the developer to the developing device.

### CROSS-REFERENCE TO RELATED APPLICATIONS

This application is based on and claims priority under 35 USC 119 from Japanese Patent Application No. 2016-058764 filed Mar. 23, 2016.

### BACKGROUND

### Technical Field

The present invention relates to a developer transport device and an image forming apparatus.

### SUMMARY

According to an aspect of the invention, a developer transport device includes a transport path through which a developer is transported from a developer container to a developing device; an inlet portion that is disposed at an upstream end of the transport path in a developer transport direction and into which the developer falls freely from an outlet opening of the developer container; a transport member that is disposed in the transport path and that transports the developer by rotating; and a rotation control unit that causes, if the transport member has not been driven for a predetermined period, the transport member to rotate in a backward direction that is opposite to a forward direction in which the transport member rotates when supplying the developer to the developing device.

### BRIEF DESCRIPTION OF THE DRAWINGS

An exemplary embodiment of the present invention will be described in detail based on the following figures, wherein:

FIG. 1 illustrates an image forming apparatus according to the exemplary embodiment of the present invention;

FIG. 2 is a partial enlarged view of the image forming apparatus according to the exemplary embodiment;

FIG. 3 illustrates a developer transport device according to the exemplary embodiment;

FIG. 4 illustrates a drive transmission system of the developer transport device according to the exemplary embodiment;

FIG. 5 is a block diagram illustrating functional blocks of a controller of the image forming apparatus according to the exemplary embodiment of the present invention;

FIG. 6 is a flowchart of a control process for the developer transport device according the exemplary embodiment; and

FIG. 7 is a flowchart of an aggregation-suppressing process according to the exemplary embodiment.

### DETAILED DESCRIPTION

Hereinafter, an exemplary embodiment of the invention will be described with reference to the drawings. Note that the present invention is not limited to the exemplary embodiment described below.

To facilitate understanding the following description, the directions in the figures are defined as follows: the front-back direction is the X-axis direction, the left-right direction is the Y-axis direction, and the up-down direction is the Z-axis direction. The directions indicated by arrows X, −X, Y, −Y, Z, and −Z are respectively forward, backward, rightward, leftward, upward, and downward; or the front side, the back side, the right side, the left side, the upper side, and the lower side.

In each of the figures, a symbol “O” with “•” in it represents an arrow extending from the back side toward the front side of the plane of the figure, and a symbol “O” with “×” in it represents an arrow extending from the front side toward the back side of the plane of the figure.

In the figures, members that are not necessary for understanding the following descriptions are not illustrated. Exemplary Embodiment

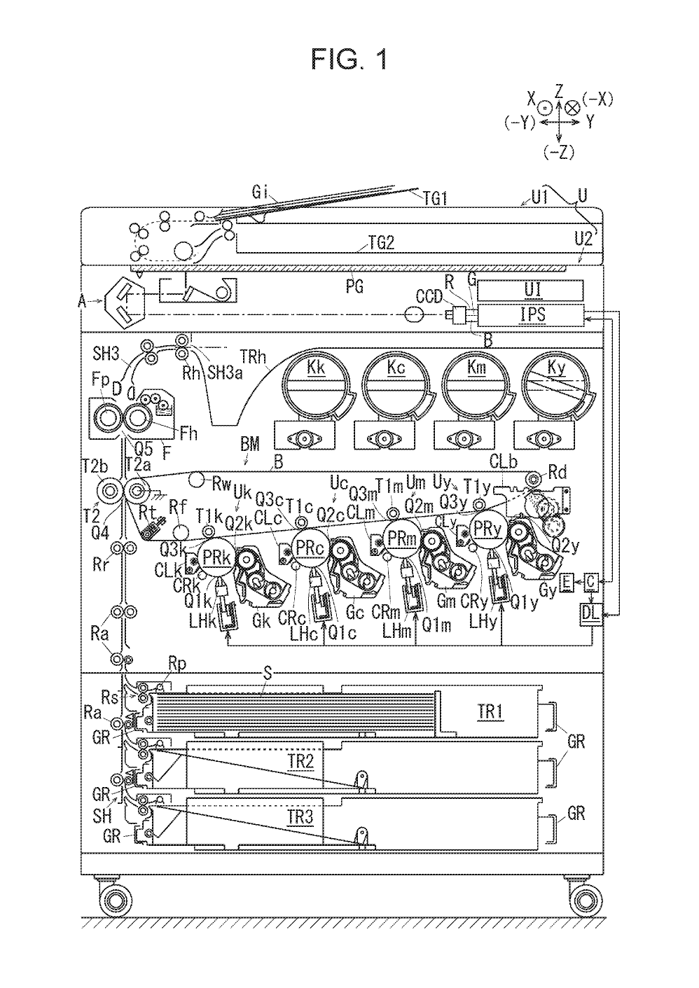

FIG. 1 illustrates an image forming apparatus according the exemplary embodiment of the present invention.

Referring to FIG. 1, a copier U, which is an example of an image forming apparatus, includes a document transport unit U1 in an upper part thereof and an apparatus body U2 in a lower part thereof.

The document transport unit U1 includes a document feeder TG1. Documents Gi to be copied are stacked on the document feeder TG1. A document output tray TG2 is disposed below the document feeder TG1. The documents Gi are fed from the document feeder TG1, pass through a document reading position on the document-reading surface PG, and are output to the document output tray TG2.

The apparatus body U2 includes an operation unit UI, an exposure system A, and the like. A user inputs operation instruction signals, such as a signal for starting an image forming operation, by using the operation unit UI.

When a document is manually placed on or automatically transported along the document reading surface PG of the document transport unit U1, light reflected from the document passes through the exposure system A and is converted by a solid-state imaging device CCD into electric signals corresponding to red (R), green (G), and blue (B).

An information converter IPS converts the RGB electric signals, input from the solid-state imaging device CCD, into image information for black (K), yellow (Y), magenta (M), and cyan (C) and stores the image information temporarily.

At a predetermined timing, the information converter IPS outputs the image information, for forming a latent image, to a latent image forming circuit DL.

If the document is a monochrome document, only image information for black (K) is input to the latent image forming circuit DL.

The latent image forming circuit DL includes driving circuits (not shown) for Y, M, C, and K, and outputs signals corresponding to input image information to LED heads LHy, LHm, LHc, and LHk, which are examples of a latent-image forming device for each color, at predetermined timings. In the exemplary embodiment, each of the LED heads LHy to LHk is an LED array in which LEDs, each of which is an example of a light-emitting device, are linearly arranged in the width direction of the image. The LEDs of the LED heads LHy to LHk emit light beams in accordance with an input signal. Accordingly, the LED heads LHy to LHk output writing beams in accordance with the input signal.

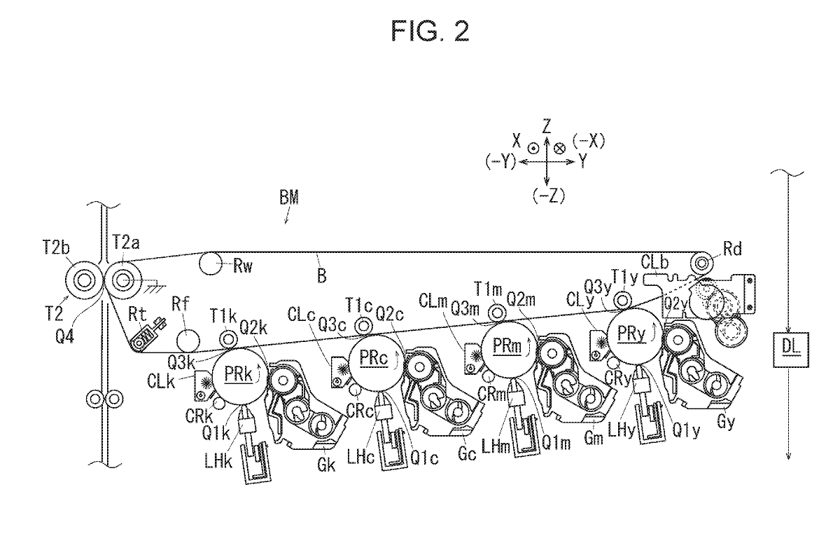

FIG. 2 is a partial enlarged view of the image forming apparatus according to the exemplary embodiment.

Referring to FIGS. 1 and 2, photoconductors PRy, PRm, PRc, and PRk, which are examples of an image carrier, are respectively disposed above the LED heads LHy to LHk.

Charging rollers CRy, CRm, CRc, and CRk, which are examples of a charger, are disposed upstream of the LED heads LHy to LHk in the rotation direction of the photoconductors PRy, PRm, PRc, and PRk so as to be in contact with the photoconductors PRy to PRk. Developing devices Gy, Gm, Gc, and Gk are disposed downstream of the LED heads LHy to LHk in the rotation direction of the photoconductors PRy to PRk. First-transfer rollers T1y, T1m, T1c, and T1k, which are examples of a first-transfer unit, are disposed downstream of the developing devices Gy to Gk in the rotation direction of the photoconductors PRy to PRk. Photoconductor cleaners CLy, CLm, CLc, and CLk, which are examples of an image-carrier cleaner, are disposed downstream of the first-transfer rollers T1y to T1k in the rotation direction of the photoconductors PRy to PRk.

The photoconductor Pry, the charging roller CRy, the LED head LHy, the developing device Gy, the first-transfer roller T1y, the photoconductor cleaner CLy for Y color constitute an image-forming unit Uy for Y color, which is an example of a visible-image forming device according to the exemplary embodiment that forms a toner image, which is an example of a visible image. Likewise, the photoconductors PRm, PRc, and PRk, the charging rollers CRm, CRc, and CRk, the LED heads LHm, LHc, and LHk, the developing device Gm, Gc, and Gk, the first-transfer rollers T1m, T1c, and T1k, the photoconductor cleaners CLm, CLc, and CLk respectively constitute image-forming units Um, Uc, and Uk for M, C, and K.

A belt module BM, which is an example of an intermediate transfer device, is disposed above the photoconductors PRy to PRk. The belt module BM includes an intermediate transfer belt B, which is an example of an intermediate transfer member and which is an endless belt. The intermediate transfer belt B is rotatably supported by a belt driving roller Rd, which is an example of a drive member; a tension roller Rt, which is an example of a tension member; a walking roller Rw, which is an example of a displacement correcting member; an idler roller Rf, which is an example of a driven member; a backup roller T2a, which is an example of a second-transfer-region counter member; and the first-transfer rollers T1y, T1m, T1c, and T1k.

A second-transfer roller T2b, which is an example of a second-transfer member, is disposed so as to face the backup roller T2a with the intermediate transfer belt B therebetween. In the exemplary embodiment, the backup roller T2a is grounded. To the second-transfer roller T2b, the electric power circuit E applies a second-transfer voltage whose polarity is the opposite to that of the charge on the toner. The backup roller T2a and the second-transfer roller T2b constitute a second-transfer unit T2 according to the exemplary embodiment. The second-transfer roller T2b and the intermediate transfer belt B are in contact with each other in a second-transfer region Q4.

A belt cleaner CLb, which is an example of an intermediate-transfer-member cleaner, is disposed downstream of second-transfer region Q4 in the rotation direction of the intermediate transfer belt B.

The first-transfer rollers T1yto T1k, the intermediate transfer belt B, the second-transfer unit T2, and the like constitute a transfer device T1+T2+B according to the exemplary embodiment. The image-forming units Uy to Uk and the transfer device T1+T2+B constitute an image recording section (Uy to Uk)+T1+T2+B according to the exemplary embodiment.

Toner cartridge Ky, Km, Kc, and Kk, which are examples of a developer container, are removably attached to positions above the belt module BM.

Referring to FIG. 1, three pairs of left and right guides rail GR, which are examples of a guide member, are vertically arranged below the image-forming units Uy to Uk. Feed trays TR1 to TR3, which are examples of a medium container, are supported by each of the guide rails GR in such a way that the feed trays TR1 to TR3 are insertable and extractable in the front-back directions. Recording sheets S, which are examples of a medium, are placed in the feed trays TR1 to TR3.

A pick-up roller Rp, which is an example of a pick-up member, is disposed above an upper left corner of each of the feed trays TR1 to TR3. Separation rollers Rs, which are examples of a separation member, are disposed downstream of the pick-up roller Rp in the transport direction of the recording sheet S. A feed path SH, which is an example of a medium transport path and which extends upward, is formed at a position downstream of the separation rollers Rs in the transport direction of the recording sheet S. Plural transport rollers Ra, which are examples of a transport member, are disposed in the feed path SH.

Registration rollers Rr, which are examples of a transport timing adjustment member, are disposed upstream of the second-transfer region Q4 in the feed path SH.

A fixing unit F is disposed downstream of the second-transfer region Q4 in the transport direction of the recording sheet S. The fixing unit F includes a heating roller Fh, which is an example of a heat fixing member, and a pressing roller Fp, which is an example of a press fixing member. The heating roller Fh and the pressing roller Fp are in contact with each other in a fixing region Q5.

A sheet output path SH3, which is an example of a transport path, is disposed above the fixing unit F. The sheet output path SH3 extends toward a sheet output tray TRh, which is an example of a medium output unit and which is formed on the upper surface of the apparatus body U2. Sheet output rollers Rh, which are examples of a medium transport member, are disposed adjacent to an output opening SH3a, which is located at the downstream end of the sheet output path SH3.

### Description of Function of Copier

With the copier U according to the exemplary embodiment having the structure described above, information of image that is read by the solid-state imaging device CCD is converted to image information for Y, M, C, and K. The LED heads LHy to LHk are controlled in accordance with the converted image information and emit writing beams.

When an image forming operation is started, the photoconductors PRy to PRk rotate. The electric power circuit E applies charging voltages to the charging rollers CRy to CRk. Accordingly, the surfaces of the photoconductors PRy to PRk are charged by the charging rollers CRy to CRk. The LED heads LHy to LHk emit the writing beams toward the charged surfaces of the photoconductors PRy to PRk to form electrostatic latent images at the writing positions Q1y, Q1m, Q1c, and Q1k on the surfaces. The developing devices Gy, Gm, Gc, and Gk develop the electrostatic latent images on the photoconductors PRy to PRk into toner images, which are examples of a visible image, in the developing regions Q2y, Q2m, Q2c, and Q2k. When developers are consumed by the developing devices Gy to Gk, the developers are supplied from the toner cartridges Ky to Kk in accordance with the consumed amounts.

The developed toner images are transported to first transfer regions Q3y, Q3m, Q3c, and Q3k, in which the photoconductors PRy to PRk are respectively in contact with the intermediate transfer belt B, which is an example of an intermediate transfer member. The first-transfer rollers T1y to T1k are disposed on the back side of the intermediate transfer belt B in the first-transfer regions Q3y, Q3m, Q3c, and Q3k. To the first-transfer rollers T1y to T1k, the electric power circuit E, which is controlled by a controller C, applies a first-transfer voltage, having a polarity opposite to that of the charge of the toner, at predetermined timings. Accordingly, the first-transfer rollers T1y to T1k transfer the toner images on the photoconductors PRy to PRk to the intermediate transfer belt B. A multiple-color toner image is formed by the transfer as follows: a toner image is transferred to the intermediate transfer belt B in a first-transfer region at an upstream position, and another toner image is transferred in an overlapping manner to the intermediate transfer belt B in another first-transfer region at a downstream position.

After the first-transfer has been finished, the photoconductor cleaners CLy to CLk clean the surfaces of the photoconductors PRy to PRk by removing substances remaining on and adhering to the surfaces. The charging rollers CRy to CRk charge the cleaned surfaces of the photoconductors PRy to PRk again.

A monochrome toner image or a multiple-color toner image, which have been transferred from the first-transfer rollers T1y to T1k to the intermediate transfer belt B in the first-transfer regions Q3y to Q3k, is transported to the second-transfer region Q4.

A recording sheet S on which an image is to be recorded is picked up by the pick-up roller Rp of one of the feed trays TR1 to TR3. If plural recording sheets S are picked up by the pick-up roller Rp, the separation rollers Rs separate the recording sheets S from each other. The transport rollers Ra transport one of the recording sheets S separated by the separation rollers Rs along the feed path SH. The recording sheet S is transported along the feed path SH to the registration rollers Rr.

The registration rollers Rr transport the recording sheet S to the second-transfer region Q4 at the same time as the toner image formed on the intermediate transfer belt B is transported to the second-transfer region Q4. To the second-transfer roller T2b, the electric power circuit E applies a second-transfer voltage having a polarity opposite to that of the charge of the toner. Accordingly, the toner image on the intermediate transfer belt B is transferred from the intermediate transfer belt B to the recording sheet S.

After the second-transfer has been finished, the belt cleaner CLb, which is an example of an intermediate transfer member cleaner, cleans the intermediate transfer belt B.

While the recording sheet S, to which the toner image has been second-transferred, passes through the fixing region Q5, the toner image is fixed to the recording sheet S.

The recording sheet S, to which the image has been fixed, is transported along the sheet output path SH3. After the recording sheet has been transported along the sheet output path SH3, the output roller Rh outputs the sheet S to the sheet output tray TRh.

### Description of Developer Supply System

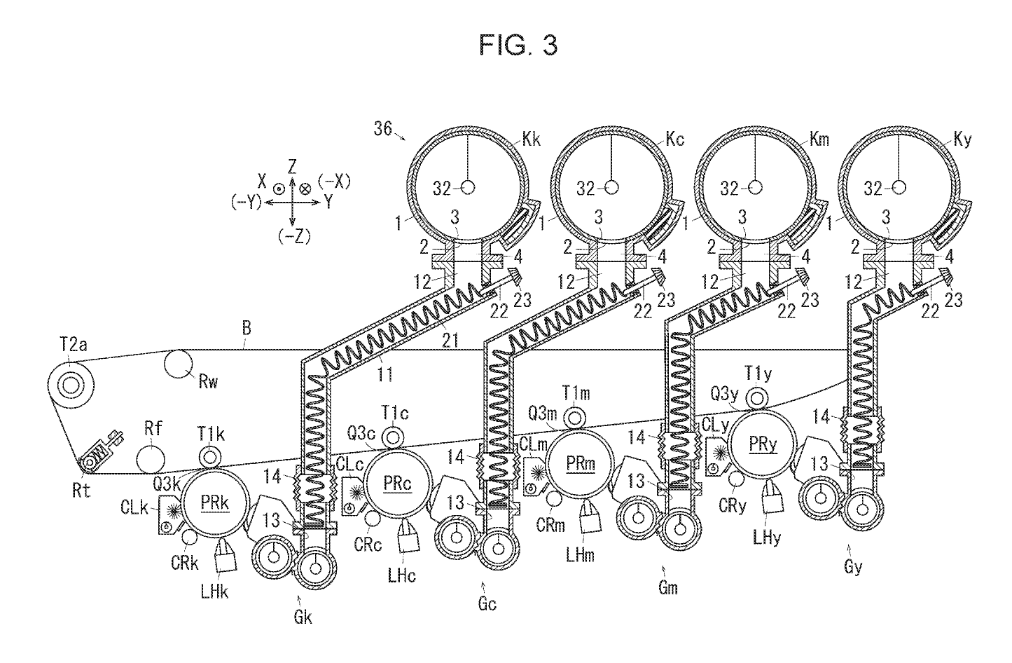

FIG. 3 illustrates a developer transport device according to the exemplary embodiment.

Referring to FIG. 3, cartridge holders 1, each of which is an example of a container holder, are disposed in an upper part of the apparatus body U2. The cartridge holders 1 are disposed so as to correspond to the toner cartridges Ky to Kk for Y, M, C, and K. Toner cartridges Ky to Kk are removably supported by the cartridge holders 1. The cartridge holders 1 have inlet portions 2, which are connected to outlet openings 3 of the toner cartridges Ky to Kk. Outlet portions 4 are connected to the inlet portions 2. The outlet portions 4 have tubular shapes extending downward.

A supply path 11, which is an example of a developer transport path, is disposed below each of the cartridge holders 1. An inlet portion 12 is disposed at an upper end of the supply path 11. An upper end of the inlet portion 12 is connected to a lower end of the outlet portion 4. The inlet portion 12 according to the exemplary embodiment has a tubular shape extending vertically. Accordingly, a developer discharged from the outlet opening 3 freely falls through the outlet portion 4 and the inlet portion 12.

The supply path 11 extends from each of the toner cartridges Ky to Kk to a corresponding one of the developing devices Gy to Gk for respective colors. In the exemplary embodiment, the lengths and the inclination angles of the supply paths 11 differ in accordance with the difference between the distances from the toner cartridges Ky to Kk for Y, M, C, and K to the developing devices Gy to Gk.

Downstream ends of the supply paths 11 are connected to supply openings 13 of the developing devices Gy to Gk. A bellows portion 14, which is an example of an adjustment portion, is disposed in a downstream portion of each of the supply paths 11. Accordingly, when displacement within an allowance occurs when attaching or removing one of the developing devices Gy to Gk to a corresponding one of the supply paths 11, the bellows portion 14 absorbs the displacement so that the downstream end of the supply path 11 may be connected to the supply opening 13.

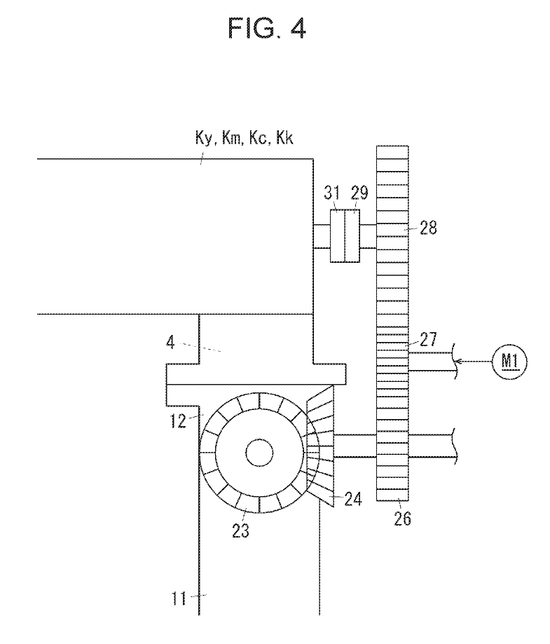

FIG. 4 illustrates a drive transmission system of the developer transport device according to the exemplary embodiment.

Referring to FIG. 3, an agitator 21, which is an example of a transport member, is disposed in each of the supply paths 11. The agitator 21 is a helically wound wire that is shaped like a coil spring. An upper end, that is, an upstream end of the agitator 21 is supported by a support member 22. The support member 22 is rotatably supported by an upper end wall of the supply path 11.

Referring to FIGS. 3 and 4, a first bevel gear 23, which is an example of a driven member, is supported by an upper end of the support member 22. Referring to FIG. 4, the first bevel gear 23 meshes with a second bevel gear 24, which is disposed behind the first bevel gear 23. A first gear 26 is supported by a shaft that supports the second bevel gear 24. The first gear 26 meshes with a drive gear 27, which is an example of a drive member. A driving force is transmitted from a supply motor M1, which is an example of a drive source, to the drive gear 27. The supply motor M1 according to the exemplary embodiment is capable of rotating forward and backward.

A second gear 28, which is an example of a driven member, meshes with the drive gear 27. A first coupling 29, which is an example of a drive-transmitting member, is support by a shaft that supports the second gear 28. A second coupling 31, which is an example of a drive-receiving member, engages with the first coupling 29. The second coupling 31 is connected to a cartridge auger 32 disposed in each of the toner cartridges Ky to Kk. The cartridge auger 32 is an example of a second transport member.

Accordingly, when the supply motor M1 rotates, the agitator 21 and the cartridge auger 32 rotate. In the exemplary embodiment, the rotation directions an the winding directions of the cartridge auger 32 and the agitator 21 are set so that, when the supply motor M1 rotates forward, the cartridge auger 32 transports a developer in a corresponding one of the toner cartridges Ky to Kk toward the outlet opening 3 and the agitator 21 transports a developer in the supply path 11 toward the supply opening 13.

The cartridge holder 1, the supply path 11, the agitator 21, the gears 23 to 28, and the like constitute a dispenser 36, which is an example of a developer transport device according to the exemplary embodiment.

Description of Controller according to Exemplary Embodiment

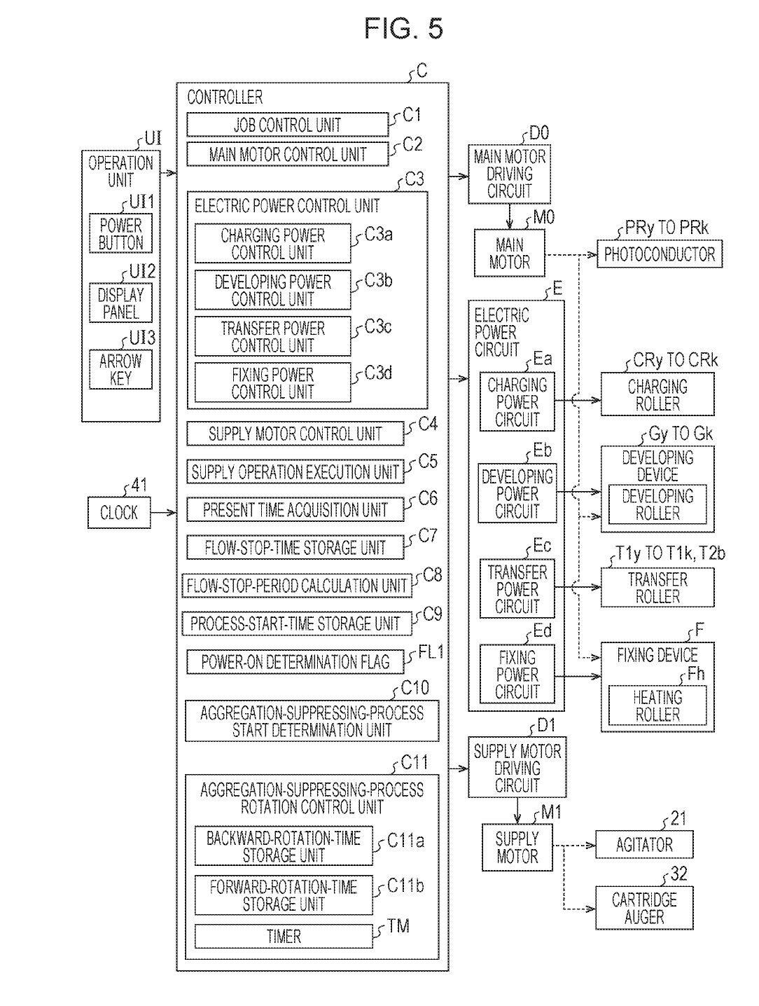

FIG. 5 is a block diagram illustrating functional blocks of the controller of the image forming apparatus according to the exemplary embodiment of the present invention.

Referring to FIG. 5, the controller C of the copier U according to the exemplary embodiment is a microcomputer, which is an example of a computer. The controller C includes an I/O interface, which is an example an input/output signal adjusting unit and which performs, for example, input and output of signals between the controller C and the outside and adjustment of the input/output signal levels. The controller C includes a read-only memory (ROM), which is an example of a storage device and which stores programs and data for executing processes. The controller C includes a hard disc drive (HDD), which is an example of a storage, for storing programs and data for executing processes. The controller C includes a random-access memory (RAM), which is an example of a storage device for temporarily storing programs and data for executing processes. The controller C includes a processor (CPU) for executing programs stored in the ROM, the HDD, and the RAM. The controller C includes a clock oscillator, which is an example of an oscillator. The controller C is capable of performing various functions by executing the programs stored in the ROM and the like.

### Signal Output Elements Connected to Controller C

Output signals from signal output elements, such as an operation unit UI and a clock 41, are input to the controller C.

The operation unit UI includes an power button UI1, which is an example of a power operation member; a display panel UI2, which is an example of a display unit and an example of a notification member; and an arrow key U13, which is an example of an input member.

The clock 41 measures the present time and outputs the present time.

### Controlled Elements Connected to Controller C

The controller C outputs controls signals of controlled elements D0, D1, and E described below.

### D0: Main Motor Driving Circuit

A main motor driving circuit D0, which is an example of a main-drive-source driving circuit, drives a main motor M0, which is an example of a main drive source, to rotate the photoconductors PRy to PRk, the heating rollers Fh of the fixing units F, the sheet output roller Rh, and the like.

### D1: Supply Motor Driving Circuit

A supply motor driving circuit D1, which is an example of a supply-drive-source driving circuit, causes the supply motor M1 to rotate the agitator 21 and the cartridge auger 32. In the exemplary embodiment, the supply motor M1 is provided for each of Y, M, C, and K colors. The supply motors M1 are driven independently.

### E: Electric Power Circuit

An electric power circuit E includes a charging power circuit Ea, a developing power circuit Eb, a transfer power circuit Ec, and a fixing power circuit Ed. The electric power circuit E supplies electric power to each member of the copier U. To be specific, the charging power circuit Ea supplies charging voltages to the charging rollers CRy to CRk. The developing power circuit Eb supplies development voltages to the developing devices Gy to Gk. The transfer power circuit Ec supplies transfer voltages to the first-transfer rollers T1y to T1k and the second-transfer roller T2b. The fixing power circuit Ed supplies electric power to a heater, which is an example of a heating member and which is disposed in the heating roller Fh of the fixing unit F.

Function of Controller C

The controller C includes the following functional units, which are implemented in programs for controlling the controlled elements in accordance with the input signals of the signal input elements.

### Cl: Job Control Unit

A job control unit Cl, which is an example of an image-forming-operation control unit, controls a job, which is an example of an image forming operation, by controlling rotation of the photoconductors PRy to PRk and application of voltages to the charging rollers CRy to CRk.

### C2: Main Motor Control Unit

A main motor control unit C2, which is an example of a main-drive-source control unit, controls a main motor M0 via a main motor driving circuit D0 to rotate the photoconductors PRy to PRk and the like.

### C3: Electric Power Control Unit

An electric power control unit C3 includes a charging power control unit C3a, a developing power control unit C3b, a transfer power control unit C3c, and a fixing power control unit C3d. The electric power control unit C3 controls the electric power circuit E to control electric power supplied to each member.

### C3a: Charging Power Control Unit

The charging power control unit C3a controls the charging power circuit Ea to control charging voltages supplied to the charging rollers CRy to CRk.

### C3b: Developing Power Control Unit

The developing power control unit C3b controls the developing power circuit Eb to control development voltages supplied to the developing devices Gy to Gk.

### C3c: Transfer Power Control Unit

The transfer power control unit C3c controls the transfer power circuit Ec to control transfer voltages supplied to the transfer rollers T1y to T1k and T2b.

### C3d: Fixing Power Control Unit

The fixing power control unit C3d controls the fixing power circuit Ed to control electric power supplied to the fixing unit F to control the fixing temperature.

### C4: Supply Motor Control Unit

A supply motor control unit C4 controls rotation of the supply motor M1 via a supply motor driving circuit D1 to control rotation of the agitator 21 and the cartridge auger 32.

### C5: Supply Operation Execution Unit

A supply operation execution unit C5 performs a supply operation of supplying developers from the toner cartridges Ky to Kk to the developing devices Gy to Gk. The amounts of supplied developers correspond to the amounts consumed by the developing devices Gy to Gk. When performing the supply operation, the supply operation execution unit C5 according to the exemplary embodiment causes the supply motor control unit C4 to rotate the supply motor M1 in the forward direction for a period corresponding to the amount of developer to be supplied.

### C6: Present Time Acquisition Unit

A present time acquisition unit C6 acquires the present time tm1, which is measured by the clock 41. In the exemplary embodiment, the present time tm1 is time information in a (year, month, day, hour, minute) format.

### C7: Flow-Stop-Time Storage Unit

A flow-stop-time storage unit C7 stores a flow-stop-time tm2, which is a time at which the developer in the supply path 11 stops flowing. The flow-stop-time storage unit C7 stores time information in the (year, month, day, hour, minute) format, which is the same as that of the present time tm1. When the supply operation is finished or when an aggregation-suppressing process (described below) is finished, the flow-stop-time storage unit C7 stores the present time tm1 as the flow-stop-time tm2.

### C8: Flow Stop Period Calculation Unit

A flow-stop-period calculation unit C8 calculates a flow-stop-period t0 for which the developer in the supply path 11 has stopped flowing. The flow-stop-period calculation unit C8 according to the exemplary embodiment calculates the flow-stop-period t0 by calculating the time elapsed from the flow-stop-time tm2 to the present time tm1. That is, t0=tm1−tm2.

### C9: Process-Start-Time Storage Unit

A process-start-time storage unit C9 stores a process-start-time ta, which is an example of a time after which the aggregation-suppressing process is to be started. In the exemplary embodiment, for example, the process-start-time ta =12 hours. The value of the process-start-time ta is not limited to this value and may be changed to any appropriate value in accordance with the design, the specifications, and the likelihood of aggregation of developer.

### FL1: Power-On Determination Flag

A power-on determination flag FL1 has an initial value “0”. When the power of the copier U is turned on, the power-on determination flag FL1 becomes “1”. While the power is on, the flag FL1 continues to be “1”. When the power of the copier U is turned off, the value of the flag FL1 is reset. That is, the flag FL1 becomes “0”.

### C10: Aggregation-Suppressing-Process Start Determination Unit

An aggregation-suppressing-process start determination unit C10 determines whether or not to start the aggregation-suppressing process, in which the agitator 21 is rotated backward. If the flow-stop-period t0 is longer than or equal to the process-start-time ta, the aggregation-suppressing-process start determination unit C10 according to the exemplary embodiment determines that the aggregation-suppressing process is to be started.

### C11: Aggregation-Suppressing-Process Rotation Control Unit

An aggregation-suppressing-process rotation control unit C11, which is an example of a rotation control unit, includes a backward-rotation-time storage unit C11a, a forward-rotation-time storage unit C11b, and a timer TM. When the aggregation-suppressing process is started, the aggregation-suppressing-process rotation control unit C11 causes the supply motor control unit C4 to rotate the supply motor M1 and controls the rotation of the agitator 21. In the aggregation-suppressing process, the aggregation-suppressing-process rotation control unit C11 rotates the agitator 21 backward. In the aggregation-suppressing process, the aggregation-suppressing-process rotation control unit C11 according to the exemplary embodiment also rotates the agitator 21 in the forward direction. In the exemplary embodiment, in the aggregation-suppressing process, the agitator 21 is rotated forward after rotated backward.

### C11a: Backward-Rotation-Time Storage Unit

A backward-rotation-time storage unit C11astores a backward-rotation-time t1 for which the agitator 21 is to be rotated backward. For example, the backward-rotation-time t1=5 seconds. The value of the backward-rotation-time t1 is not limited to this value and may be changed to any appropriate value in accordance with the design, the specifications, and the degree of difficulty in crumbling aggregated developer.

### C11b: Forward-Rotation-Time Storage Unit

The forward-rotation-time storage unit C11b stores a forward-rotation-time t2 for which the agitator 21 is to be rotated forward. In the exemplary embodiment, the value of the forward-rotation-time t2 is equal to the value of the backward-rotation-time t1.

### TM: Timer

A timer TM, which is an example of a time measuring unit, stores the time t1 and the time t2, for which the agitator 21 is to be rotated.

### Description of Flowchart

Next, a flowchart of the exemplary embodiment will be described. Processing of each step of the flowchart is performed by executing a program stored in the controller C of the copier U. The processing is executed concurrently with other processing performed by the copier U.

### Description of Flowchart of Dispenser Control Process

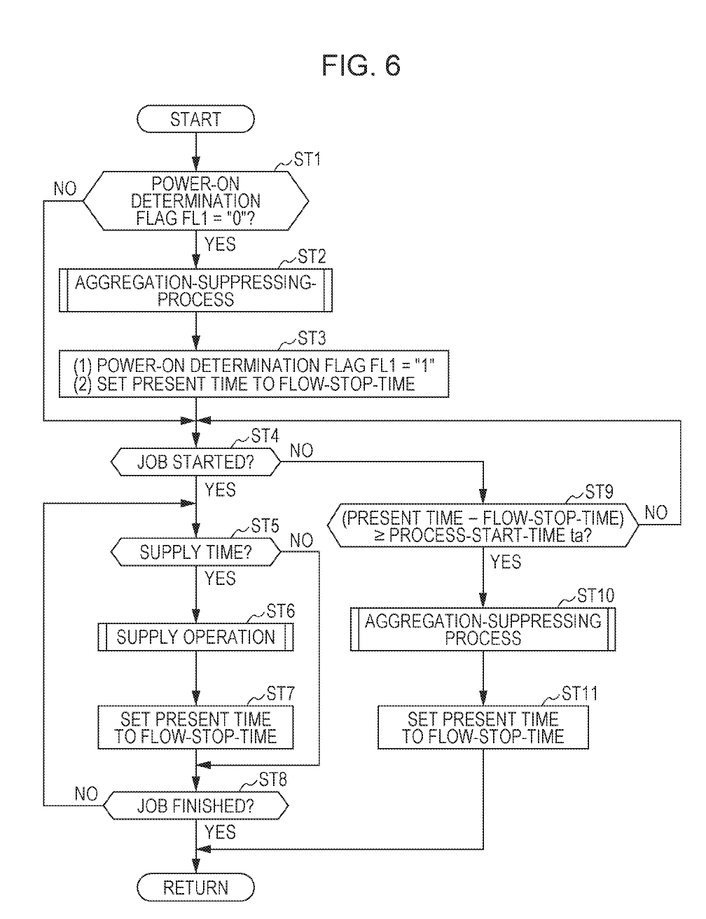

FIG. 6 is a flowchart of a process for controlling the developer transport device according to the exemplary embodiment.

The process shown in FIG. 6 starts when the power of the coper U is turned on.

In step ST1of FIG. 6, whether or not the power-on determination flag FL1 is “0” is determined. In other words, whether or not the power has just been turned on is determined. If the determination is yes (Y), the process proceeds to step ST2. If the determination is no (N), the process proceeds to step ST4.

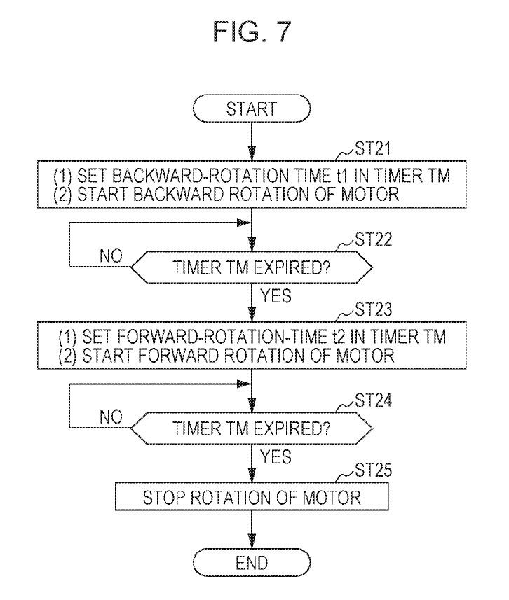

In step ST2, the aggregation-suppressing process, in which the agitator 21 is rotated backward, is performed, and the process proceeds to step ST3. The aggregation-suppressing process will be described below with reference to FIG. 7.

In step ST3, the following processing operations (1) and (2) are performed, and the process proceeds to step ST4.

(1) The value of the power-on determination flag FL1 is changed to “1”.

(2) The present time tm1 is stored as the flow-stop-time tm2.

In step ST4, whether or not the job has been started is determined. If the determination is yes (Y), the process proceeds to step ST5. If the determination is no (N), the process proceeds to step ST9.

In step ST5, whether or not it is the time to supply the developers is determined in accordance with the consumption of the developers by the developing devices Gy to Gk. If the determination is yes (Y), the process proceeds to step ST6. If the determination is no (N), the process proceeds to step ST8.

In step ST6, the supply operation is performed by rotating the supply motor M1 forward for a time corresponding to the amount of developer to be supplied. Description of the details of the supply operation, which may be performed by any known method, will be omitted. Then, the process proceeds to step ST7.

In step ST7, the present time tm1 is stored as the flow-stop-time tm2. Then, the process proceeds to step ST8.

In step ST8, whether or not the job has finished is determined. If the determination is no (N), the process returns to step ST5. If the determination is yes (Y), the process returns to step ST1.

In step ST9, whether or not the flow-stop-period t0 (=(present time tm1)−(flow-stop-time tm2)) is longer than or equal to the process-start-time to is determined. If the determination is yes (Y), the process proceeds to step ST10. If the determination is no (N), the process returns to step ST4.

In step ST10, the aggregation-suppressing process, in which the agitator 21 is rotated backward, is performed, and the process proceeds to step ST11. The aggregation-suppressing process will be described below with reference to FIG. 7.

In step ST11, the present time tm1 is stored as the flow-stop-time tm2. Then, the process returns to step ST1.

### Description of Flowchart of Aggregation-Suppressing Process

FIG. 7 is a flowchart of the aggregation-suppressing process according to the exemplary embodiment.

In step ST21of FIG. 7, the following processing operations (1) and (2) are performed, and the process proceeds to step ST22. (1) The backward-rotation-time t1 is set in the timer TM. (2) Backward rotation of the supply motor M1 is started.

In step ST22, whether or not the timer TM has expired, that is, whether or not the backward-rotation-time t1 has elapsed is determined. If the determination is yes (Y), the process proceeds to step ST23. If the determination is no (N), step ST22 is repeated.

In step ST23, the following processing operations (1) and (2) are performed, and the process proceeds to step ST24. (1) The forward-rotation-time t2 is set in the timer TM. (2) Forward rotation of the supply motor M1 is started.

In step ST24, whether or not the timer TM has expired, that is, whether or not the forward-rotation-time t2 has elapsed is determined. If the determination is yes (Y), the process proceeds to step ST25. If the determination is no (N), step ST24 is repeated.

In step ST25, rotation of the supply motor M1 is stopped. Then, the aggregation-suppressing process shown in FIG. 7 is finished, and the process returns to the start of the process shown in FIG. 6.

### Function of Developer Transport Device

With the copier U according to the exemplary embodiment, which has the structure described above, when the job is started, the supply motor M1 is rotated forward in accordance with the amount of developer consumed in each of the developing devices Gy to Gk. Accordingly, the agitator 21 and the cartridge auger 32 rotate forward and the developer in a corresponding one of the toner cartridges Ky to Kk falls through the outlet portion 4 and the inlet portion 12, and the developer is transported downstream through the supply path 11.

When the flow-stop-period t0, which is measured from the time at which the agitator 21 was stopped, becomes longer than or equal to the process-start-time ta, the aggregation-suppressing process is started. Accordingly, the agitator 21 rotates backward, and the developer in the supply path 11 flows upstream. Accordingly, the developer in the outlet portion 4 and the inlet portion 12 is pushed in the upstream direction, and thereby aggregation of the developer is suppressed.

With the technology described in Japanese Unexamined Patent Application Publication No. 2004-233492, when a load increases due to aggregation of developer or the like, the developer is crumbled by using vibration that occurs when the entirety of the toner cartridge rotates and collides with the stopper. However, this technology has a problem in that noise is generated when the toner cartridge collides with the stopper. In particular, it is described in Japanese Unexamined Patent Application Publication No. 2004-233492 that the toner cartridge collides with the stopper multiple times to crumble the developer. In this case, loud noise is generated and a user may misunderstand that a malfunction has occurred. Moreover, an image defect may occur due to vibration caused by the collision. There is also a problem in that a complicated structure is necessary to rotate the entirety of the toner cartridge. In order to rotate the toner cartridge, which has a large weight, it is necessary that the stopper and the toner cartridge have sufficient strength so as to avoid breakage due to the collision. Thus, the structures of the toner cartridge and the related components become complicated, and a problem arises in that the size and the cost of the image forming apparatus are increased.

In contrast, with the exemplary embodiment, if a long period elapses after the agitator 21 was stopped, the agitator 21 rotates backward to transport the developer upstream in the supply path 11. Accordingly, the developer is crumbled while flowing upstream and aggregation is suppressed. Thus, compared with the structure described in Japanese Unexamined Patent Application Publication No. 2004-233492, generation of noise is suppressed and an image defect due to vibration is suppressed, and the occurrence of developer transport failure due to blocking of the supply path 11 by aggregated developer is reduced. Moreover, compared with the structure described in Japanese Unexamined Patent Application Publication No. 2004-233492, a complicated mechanism for suppressing aggregation of developer is not necessary, sot that increase in the size and the cost of the copier U is suppressed.

If an aggregation-suppressing process is performed by rotating the agitator 21 forward, the developer is supplied to each of the developing devices Gy to Gk. Accordingly, the amount of developer in each of the developing devices Gy to Gk may become excessive, and development failure may occur. In contrast, with the exemplary embodiment, because the agitator 21 is rotated backward, the developer is not supplied to each of the developing devices Gy to Gk. Thus, the occurrence of development failure is also reduced.

If the cartridge auger 32 does not rotate and only the agitator 21 rotates backward, when a part of the supply path 11 near the outlet opening 3 is filled with a developer, the developer in the outlet portion 4 and the inlet portion 12 receives a force due to the backward rotation of the agitator 21 and is not allowed to move upward. Accordingly, the developer in the outlet portion 4 and the inlet portion 12 may become compressed and aggregated. In contrast, with the exemplary embodiment, the cartridge auger 32 of each of the toner cartridges Ky to Kk is rotated backward together with the agitator 21. Accordingly, the developer near the outlet opening 3 is transported in such a direction that the developer is removed. Thus, the developer in the outlet portion 4 and the inlet portion 12 is allowed to move upward through the outlet opening 3, that is, into the toner cartridges Ky to Kk. Accordingly, aggregation of the developer in the outlet portion 4 and the inlet portion 12 is suppressed.

In the aggregation-suppressing process according to the exemplary embodiment, after rotating the agitator 21 backward, the agitator 21 is rotated forward. Accordingly, a developer that has flowed upstream is returned to the original position before flowing upstream. In particular, in the exemplary embodiment, the backward-rotation-time t1 is equal to the forward-rotation-time t2, so that the developer that has flowed upstream easily returns to the original position before flowing upstream. If the agitator 21 is only rotated backward and is not rotated forward, when supplying a developer to perform an image forming operation next time, it is necessary to return the developer that has flowed upstream to the original position and it takes an additional time. Thus, supply of the developer is delayed, and development failure such as insufficient density of an image may occur. In contrast, with the exemplary embodiment, compared with a case where the agitator 21 is not rotated forward after being rotated backward, delay in supply of developer in the next operation of supplying the developer is reduced.

With the exemplary embodiment, the aggregation-suppressing process is not performed while the job is being performed. Thus, the aggregation-suppressing process does not interfere with an operation of supplying developer during the job. Accordingly, it is not necessary to supply a developer to a corresponding one of the developing devices Gy to Gk during the aggregation-suppressing process, and delay in supply of the developer during the job is prevented.

With the exemplary embodiment, the aggregation-suppressing process is performed when the power is turned on. Accordingly, even if a period for which the power has been off is not recognizable, the aggregation-suppressing process is performed and the occurrence of developer transport failure is reduced.

### Modifications

The present invention is not limited to the exemplary embodiment described above, and the exemplary embodiment may be modified in various ways within the sprit and scope of the present invention described in the claims. Examples of the modifications include the following (H01) to (H07).

(H01) In the exemplary embodiment, the copier U is described as an example of an image forming apparatus. However, this is not a limitation. For example, the image forming apparatus may be a printer, a facsimile machine, or a multifunctional machine having some or all of copying, printing, and facsimilia functions.

(H02) In the exemplary embodiment, the copier U uses four color developers. However, this is not a limitation. The image forming apparatus may use a monochrome developer, three color developers, or five or more color developers.

(H03) In the exemplary embodiment, the aggregation-suppressing process is not performed while the job is being performed. However, this is not a limitation. For example, when a monochrome printing job is performed by using a developer for K color, even while the job is being performed, developers are not supplied to the dispensers 36 for Y, M, and C. Therefore, it is possible to perform the aggregation-suppressing process if the flow-stop-period t0 becomes longer than or equal to the process-start-time ta. Alternatively, the job may be temporarily stopped to perform the aggregation-suppressing process. If some of the dispensers 36 satisfy the conditions for starting the aggregation-suppressing process during the job, the aggregation-suppressing process need not be performed during the job and may be performed after finishing the job.

(H04) In the exemplary embodiment, in the aggregation-suppressing process, preferably, not only the backward rotation but also the forward rotation is performed. However, the forward rotation need not be performed.

(H05) In the exemplary embodiment, in the aggregation-suppressing process, the backward-rotation-time t1 is equal to the forward-rotation-time t2. However, this is not a limitation. For example, while the forward rotation is performed, if the developer returns to the original position due to gravity faster than in a case where the developer flows upstream in the supply path 11, the forward-rotation-time t2 may be shorter than the backward-rotation-time t1. If, in contrast to the exemplary embodiment, the supply path has a structure with which the developer moves in a shorter time when the forward rotation is performed than when the backward rotation is performed, such as a structure in which the supply path is inclined upward in the downstream direction, the forward-rotation-time t2 may be longer than the backward-rotation-time t1.

(H06) In the exemplary embodiment, the agitator 21 and the cartridge auger 32 are rotated forward or backward in synchronism. However, this is not a limitation. For example, if the lengths of the outlet portion 4 and the inlet portion 12 are sufficiently large, and a developer in the outlet portion 4 and the inlet portion 12 is movable upward without rotating the cartridge auger 32 and the agitator 21, it is not necessary that the cartridge auger 32 and the agitator 21 rotate backward in synchronism.

(H07) In the exemplary embodiment, the cartridge auger 32 is disposed in each of the toner cartridges Ky to Kk. However, this is not a limitation. The entirety of the toner cartridges Ky to Kk may rotate to transport the developer.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A developer transport device comprising:
a transport path through which a developer is transported from a developer container to a developing device;
an inlet portion that is disposed at an upstream end of the transport path in a developer transport direction and into which the developer falls freely from an outlet opening of the developer container;
a transport member that is disposed in the transport path and that transports the developer by rotating; and
a rotation control unit that causes, in response to the transport member not being driven for a predetermined period of time, the transport member to rotate in a backward direction that is opposite to a forward direction in which the transport member rotates when supplying the developer to the developing device.

2. The image forming apparatus of claim 11,
wherein the rotation control unit causes the transport member to rotate also in the forward direction if the rotation control unit causes the transport member to rotate in the backward direction.

3. The image forming apparatus according to claim,
wherein the rotation control unit causes the transport member to rotate in the forward direction after causing the transport member to rotate in the backward direction.

4. The image forming apparatus according claim 2,
wherein a period for which the rotation control unit causes the transport member to rotate in the backward direction is equal to a period for which the rotation control unit causes the transport member to rotate in the forward direction.

5. The developer transport device according to claim 3,
wherein a period for which the rotation control unit causes the transport member to rotate in the backward direction is equal to a period for which the rotation control unit causes the transport member to rotate in the forward direction.

6. The developer transport device according to claim 1, further comprising:
a drive source that drives the transport member in the backward direction also drives a second transport member disposed in the developer container in a backward direction.

7. The image forming apparatus according to claim 2, further comprising:
a drive source that drives the transport member in the backward direction also concurrently drives a second transport member disposed in the developer container in a backward direction.

8. The developer transport device according to claim 3, further comprising:
a drive source that drives the transport member in the backward direction also drives a second transport member disposed in the developer container in a backward direction.

9. The image forming apparatus according to claim 4, further comprising:
a drive source that drives the transport member in the backward direction also drives a second transport member disposed in the developer container in a backward direction.

10. The developer transport device according to claim 5, further comprising:
a drive source that drives the transport member in the backward direction also drives a second transport member disposed in the developer container in a backward direction.

11. An image forming apparatus comprising:
an image carrier;
a latent-image forming device that forms a latent image on the image carrier;
a developing device that develops the latent image on the image carrier into a visible image;
the developer transport device according to claim 1 that transports and supplies the developer to the developing device;
a transfer device that transfers the visible image on the image carrier to a medium; and
a fixing unit that fixes the visible image to the medium.
